(19) United States
(12) Patent Application Publication
(10) Pub. No.: US 2007/0133359 A1
(43) Pub. Date: Jun. 14, 2007

(54) Label on laser entry side of an optical disc

(75) Inventors: Andrei Mijiritskii, Eindhoven (NL); Erwin Rinaldo Meinders, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/598,000

(22) PCT Filed: Feb. 3, 2005
(86) PCT No.: PCT/IB05/50456

§ 371 Date: Aug. 15, 2006

(30) Foreign Application Priority Data
Feb. 19, 2004 (EP) 04100651.1

(51) Int. Cl. G11B 13/00; G11B 7/085; G06K 19/06

(52) U.S. Cl. 369/14; 369/30.1; 235/494

(57) ABSTRACT

An optical disc (3) for storing data is provided with a label material layer (8) on a laser entry side of the disc (3). The label material layer (8) does not impede reading data from or writing data onto the disc (3). Reflection or absorption of light in the visual spectrum by the label material in the label material layer (8) is affectable by illuminating the label material according to a label pattern. Changing the reflection or absorption results in a local change of color. The contrast that is herewith applied to the label material layer (8) can be used for creating visual information, such as text or images for forming a label. Furthermore a device (52) is provided for applying a label to the laser entry side of an optical disc (3). The device (52) comprises means for producing a laser beam (21) for illuminating the label material layer (8) according to a label pattern.

The invention relates to an optical disc for storing data, the optical disc comprising at least one data layer and a transparent layer, the data being retrievable from the data layer via the transparent layer by a reading laser beam, the transparent layer comprising label material for forming a label at a laser entry side of the disc by reflection or absorption of light at a range of wavelengths in the visual spectrum, the label material being substantially transparent for light at the wavelength of the reading laser beam.

The invention further relates to a method for applying a label to a laser entry side of an optical disc as described in the opening paragraph. The invention also relates to a device for applying a label to a laser entry side of an optical disc as described in the opening paragraph.

The Japanese patent application JP11003543 describes an information recording medium from which data can be reproduced from both sides. A label, large enough to be read, is attached to the information recording medium.

The information recording medium is an optical disc comprising a data layer on a supporting substrate. The data on the data layer is reproduced by irradiating and focusing a laser beam on the data layer through a transparent layer. A label pattern film comprising label material is formed on top of the transparent layer at a laser entry side of the disc. The optical properties of the label material are such that transparency is large at approximately the wavelength of the laser beam for reproducing the data and reflectance or absorption is large at other wavelengths in the visual spectrum. Hence a visual label pattern is presented to the user at the laser entry side of the disc while readout of the data by the light beam is not impeded.

A drawback of the label pattern film according to said application is that the label pattern film has to be provided on the disc during the process of manufacturing the disc.

It is an object of the invention to provide an optical disc in which it is possible to apply a label on a laser entry side after manufacture of the disc.

With the optical disc of the invention this object is realized in that the reflection or absorption of light at a range of wavelengths in the visual spectrum is affectable by locally illuminating the label material for the forming of the label. The illuminating is realized by a light source emitting light at a wavelength suitable for affecting the reflection or absorption of the label material.

The method according to the present invention comprises the step of illuminating the label material according to a label pattern for affecting reflection or absorption of light by the label material.

The device according to the present invention comprises means for illuminating the label material according to a label pattern at a wavelength suitable for affecting the reflection or absorption of light by the label material.

An embodiment of the device according to the present invention is foreseen, wherein the means for locally illuminating comprise means for producing a laser beam for illuminating the label material at the wavelength suitable for affecting the reflection or absorption of light by the label material, positioning means for positioning the laser beam at areas of the label material layer in which areas the reflection or absorption is to be affected and focusing means for focusing the laser beam to obtain a laser spot with desired dimensions on the label material layer. The desired dimensions are such that a label is applied with a predetermined resolution. For high resolution labels a small spot size is required. For low resolution labels a larger spot size is used.

The invention relies on the fact that optical properties, like reflection or absorption of light at a range of wavelengths in the visual spectrum, of some materials change when the material is exposed to light at particular wavelengths and with a certain intensity. A local change in reflection or absorption of light in the visual spectrum of the material used in the label material layer of the optical disc may change the perceived color of the affected area. Due to local illumination of the label material, specific areas of the label material layer may have a color different from other areas. The contrast that is herewith applied to the label material layer can be used for storing visual information. Because the label material is substantially transparent for light at the wavelength of the reading and/or writing laser beam it will not impede retrieval of data stored on the disc and/or writing of data onto the disc and thus it is possible to attach the label to the laser entry side of the disc.

The user may personally design the label provided on the laser entry side of the disc after disc manufacture, to obtain a label carrying relevant information. Several methods are known for a user to apply a label to the side opposite to the laser entry side of the disc. A label can be glued to the disc, drawn with a pen or printed with a dedicated label printer. The labels applied by these known methods are basically not transparent for light at the wavelength of the reading laser beam. Therefore the known methods can not be used for applying a self made label to the laser entry side of an optical disk. With the growing demand for data storing capacity double sided discs have been introduced. In double sided discs data layers are placed on both sides of the discs. If both sides of the disc function as a laser entry side, it is extremely inconvenient to place one of the known labels on the disc.

It is an advantage of the optical disc according to the present invention that a user made label can be applied to double sided discs. Another advantage of the invention is the possibility to apply a self made label to one or both sides of an optical disc. A disc with labels on both sides can be easily identified no matter what side is visible. Furthermore a disc with labels on both sides can carry more label information than a disc with a label at just one side.

These and other aspects of the invention are apparent from and will be elucidated with reference to the embodiments described hereinafter.

In the drawings:

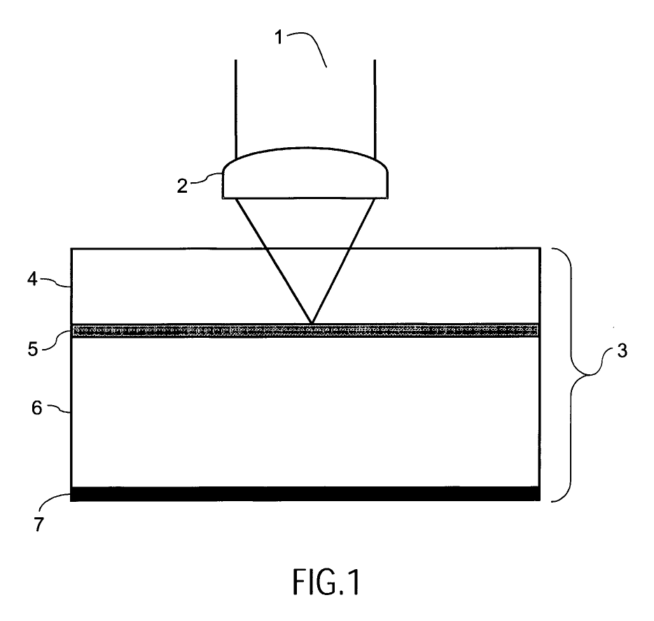

FIG. 1 is a schematic cross section of a prior art single sided optical disc from which data is being read by a reading laser beam,

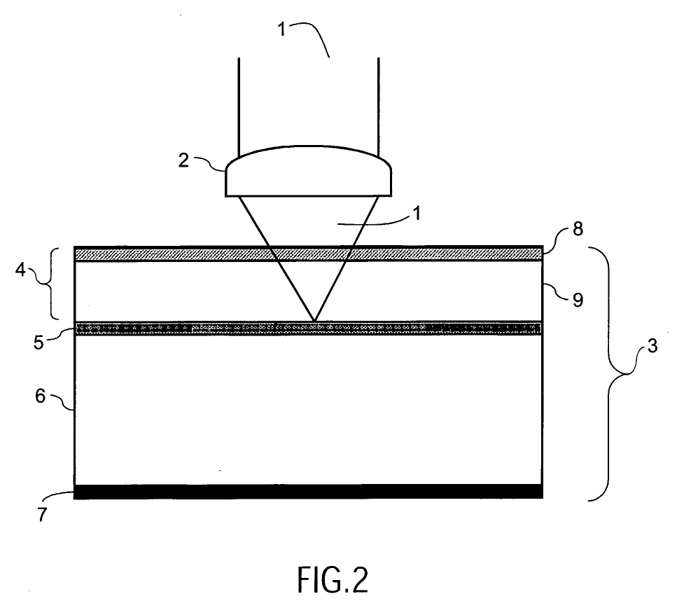

FIG. 2 is a schematic cross section of a single sided optical disc according to the present invention from which data is being read by a reading laser beam,

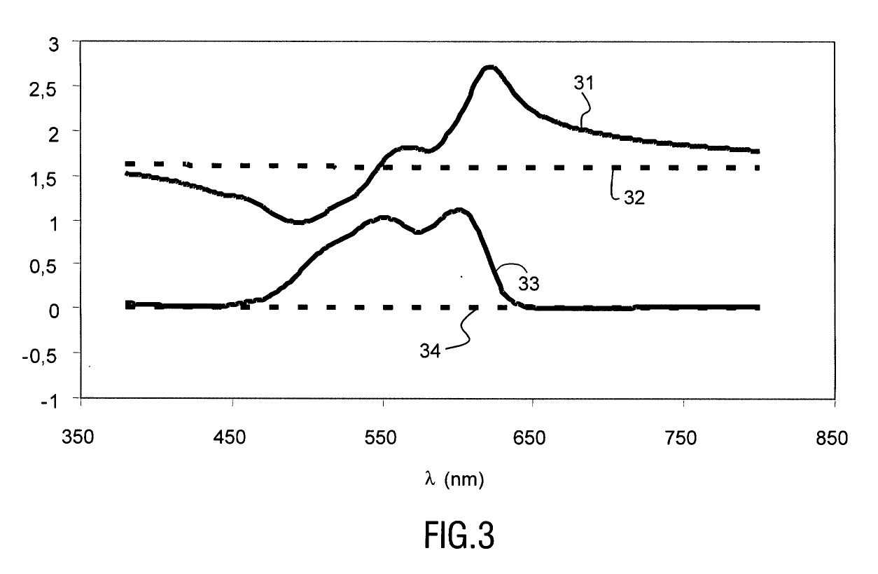

FIG. 3 is a graph showing reflection and absorption of polycarbonate and an organic photosensitive label material,

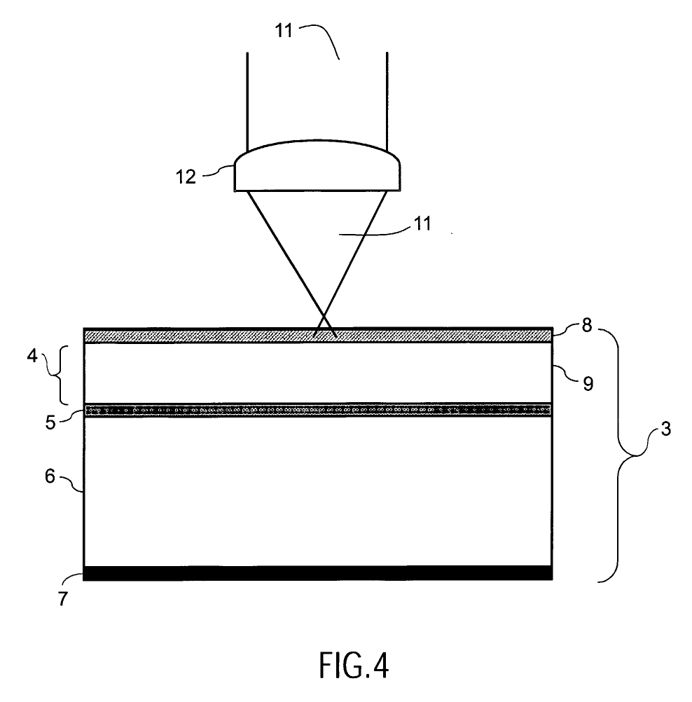

FIG. 4 is a schematic cross section of a single sided optical disc according to the present invention to which a label is applied by illumination,

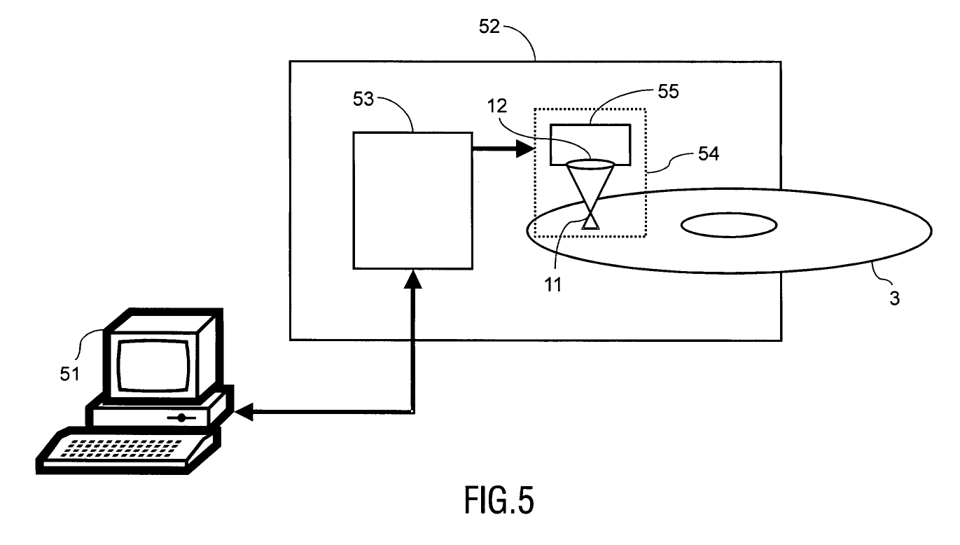

FIG. 5 is a block diagram of an embodiment of a device according to the present invention,

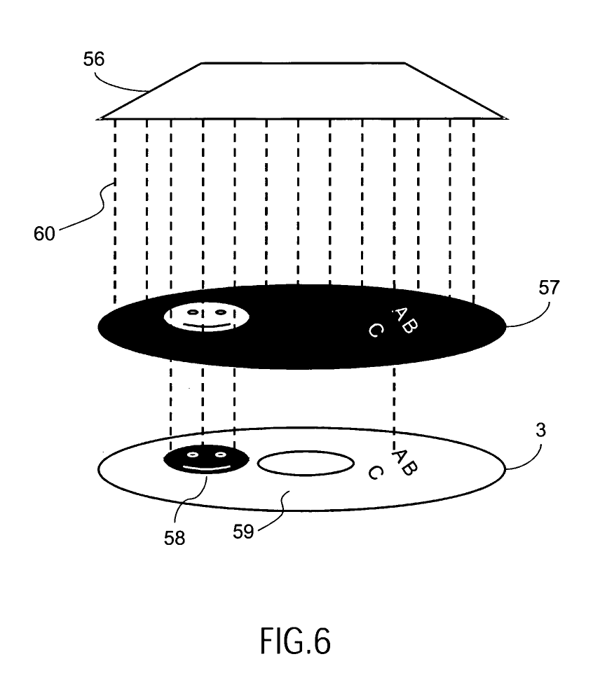

FIG. 6 is a schematic representation of the process of illuminating a label material layer, using a light source and a label mask,

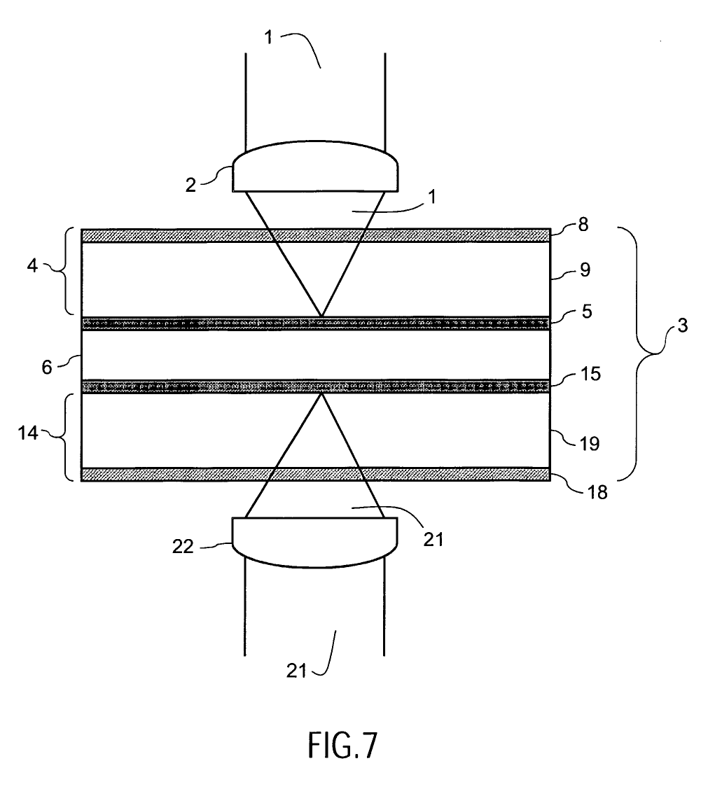

FIG. 7 is a schematic cross section of a double sided optical disc according to the present invention from which data is being read by a reading laser beam,

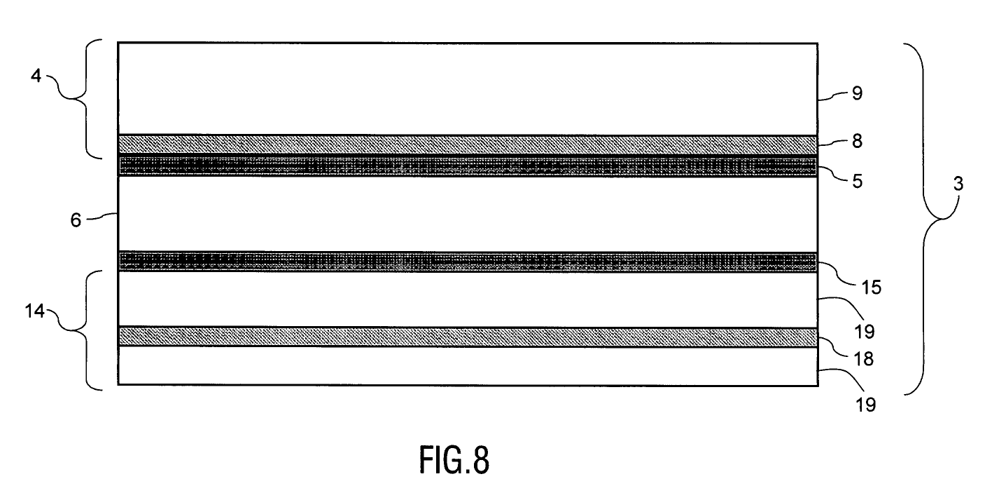

FIG. 8 is a schematic cross section of a double sided optical disc according to the present invention showing two options for placement of the label material, and

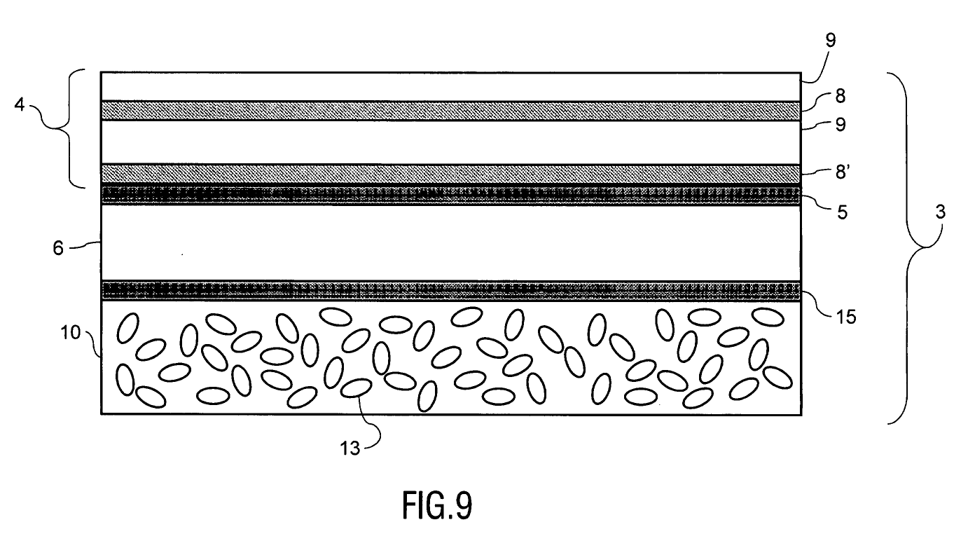

FIG. 9 is a schematic cross section of a double sided optical disc according to the present invention showing two additional options for placement of the label material.

In the diagrams below, similar references designate similar elements.

FIG. 1 shows a schematic cross section of a prior art single sided optical disc 3 from which data is being read by a reading laser beam 1. The reading laser beam 1 is focused on the data layer 5 of the optical disc 3 by a lens 2. A transparent layer 4, substantially transparent for light at the wavelength of the laser beam 1 is attached to the data layer and is situated between the data layer 5 and the lens 2. For example, polycarbonate, polymethyl methacrylate (PMMA) or resin may be used for forming the transparent layer 4. For writing data onto the data layer a writing laser beam (not shown) at a predetermined wavelength and with the required intensity is used. Typically the same laser, emitting light at the same wavelength is used for writing data onto the data layer as for retrieving data. The intensity of the writing laser beam is usually higher for writing data than for reading data. The data layer 5 is supported by a disc substrate layer 6 which, for example, is also made up of polycarbonate. On the side opposite to the laser entry side of the optical disc 3 a label 7 is attached. The label 7 is used for providing visual information about the content of the optical disc 3 to a user. This label is not permeable for the light of the reading laser beam 1 or the writing laser beam.

FIG. 2 shows a schematic cross section of a single sided optical disc 3 according to the invention. The optical disc comprises all features already shown in FIG. 1. In this embodiment the transparent layer 4 comprises a substrate layer 9 and a label material layer 8. The substrate layer 9 again may be made of polycarbonate. The label material layer 8 forms a label at the laser entry side of the disc. The label material layer 8 may be formed by a spin coating process. The total optical thickness of the substrate layer 9 plus the label material layer 8 has to be within the limits for predefined standards for storage mediums (e.g. DVD, CD, BD). After a label has been formed in label material layer 8, the label material locally reflects or absorbs light at a range of wavelengths in the visual spectrum. Some parts of the label material layer 8 reflect or absorb light, resulting in the perception of a color by the user. Other parts of the label material layer 8 are transparent or have another color. The contrast between the transparent and non transparent parts or the contrast between two non transparent parts having a different color is used for applying a label to the laser entry side of the disc 3. The reflection or absorption is affectable by illuminating the label material with a light source emitting light at a wavelength suitable for affecting the reflection or absorption of the label material. The label material is substantially transparent for light at the wavelength of the reading laser beam 1 or of a writing laser beam. Therefore the label material layer 8 does not impede reading data from or writing data onto the data layer 5 of the optical disc 3.

Organic photosensitive dyes are used as label material. The optical properties of an exemplary dye in an unrecorded state are shown in FIG. 3. In this figure the reflection coefficient 31 and absorption coefficient 33 of the dye for light at different wavelengths are shown together with the reflection coefficient 32 and absorption coefficient 34 of polycarbonate. As can be seen this dye is particularly absorptive for green light and reflective for red light. In the unrecorded state the dye will have a certain color and the complete disc surface will have the same color. The color of the label not only depends on the color of the used dye but also depends on the colors of underlying layers. Like polycarbonate the dye is substantially transparent for light at a wavelength of about 405 nm. Hence this particular dye is particularly suited for use in Blu-ray discs (BD). Exposing the particular dye to light of sufficient intensity in the region of absorption, between 500 and 600 nm for this dye, leads to bleaching of the dye. The bleaching of the dye is accompanied by a change in optical parameters, such that these match the optical properties of the polycarbonate of the substrate layer 9. After locally illuminating the dye layer, the illuminated areas of the label material layer 8 will be substantially transparent. The visibility of the label is caused by the contrast between the original color and transparent areas of the label material layer. The transparency of the dye for light at the wavelength of about 405 nm is not substantially changed by the illumination. Hence reading of data from the data layer is not impeded by the illumination. Other dyes like cyanine, phthalocyanine and metallized azo dyes are well known from CD recording techniques and are particularly suitable for using as label material in an optical disc according to the present invention.

The wavelength for illuminating the label material is usually different from the wavelengths of the reading laser beam 1 and the writing laser beam because otherwise the presence of the label would affect disc performance too much.

FIG. 4 is a schematic cross section of a single sided optical disc 3 to which a label is being applied by illumination. The optical disc 3 comprises all features of the disc already shown in FIG. 2. For applying the label to the optical disc 3 a lens 12 focuses a laser beam 11 at the label material layer 8 for illuminating the label material with light of sufficient intensity. The wavelength and the intensity of the light of the laser beam 11 is such that locally illuminating the label material with the laser beam 11 results in dye bleaching and thus a changed reflection and absorption of light in the visual spectrum by the label material.

FIG. 5 shows a block diagram of an embodiment of a label recording device 52 according to the present invention. In this embodiment the device is coupled to a personal computer 51, further referred to as PC 51. The PC 51 comprises software for a user to design a label and instruct the device 52 to record the label on the label material layer 8 of the optical disc 3. The device 52 comprises a control unit 53 for controlling the label writing process and a label writing unit 54, comprising a laser beam producing unit 55 and a lens 12, for focusing the laser beam 11 to illuminate the label material layer 8 of the optical disc 3.

The device 52 may be an external device coupled to the PC 51 via USB, communication ports, Internet, wireless networks or other communication means. The device 52 may also be an internal device integrated with the PC 51 like a regular IDE CD-ROM drive. The PC 51 communicates with a control unit 53 of the device 52. The control unit 53 controls a drive unit (not shown) which rotates the optical disc 3. The control unit 53 further controls the label writing unit 54 to move radially along the rotating disc 3. In this manner the entire surface area of the disc can be reached with the laser beam 11. The label writing unit 54 comprises the laser beam producing unit 55 and the lens 12 for focusing the laser beam 11 on the label material layer 8 of the optical disc 3. While the writing unit 54 moves over the surface of the optical disc 3, the laser beam producing unit 55 turns the laser beam 11 repeatedly on and off. Hence some parts of the label material layer 8 are illuminated, while other parts are not. The contrast between illuminated and non illuminated parts of the label material layer 8 is used for applying visual information to the laser entry side of the optical disc 3.

The lens 12 focuses the laser beam 11 on the label material layer 8. The spot of the laser beam 11 is preferably larger than the spot of a laser beam used for reading data from or writing data onto an optical disc. With a small laser spot only relatively small areas of the label material layer 8 will be illuminated. Hence a small laser spot will result in a high resolution, but also in a longer time required for writing a label large enough for offering a user visual information. When the spot size is about 10 times as large as the usual spot size for writing or reading a CD, the resolution of the label is similar to the resolution of a modern laser printer (1200 dpi). In the current embodiment this larger spot size is obtained with a conventional laser, suited for reading data from or writing data onto optical discs, by focusing the laser beam some distance above the disc surface. The spot size may be selected differently if another resolution of the label is desired. It is to be noted that a larger spot size will reduce the intensity of the light falling onto the label material layer 8. The intensity of the laser beam has to be sufficient for affecting the optical properties of the label material.

In an embodiment the device is arranged for producing laser beams at three different wavelengths. One wavelength is suited for writing data onto the data layer 5 of the optical disc 3. One wavelength is suited for reading data from the data layer and one wavelength is suited for writing a label by affecting the optical properties of label material in the label material layer 8. Using different wavelengths for reading data, writing data and writing a label reduces the chance of unintendedly changing the label or the data content during reading data, writing data or label writing.

For Blu-ray Disc data is read-out and written using a blue laser. An embodiment of the device, particularly suited for applying a label to a Blu-ray Disc is based on illumination with red light. FIG. 6 is a schematic representation of the process of illuminating a label material layer 8, using a light source 56 and a label mask 57. The label mask 57 comprises areas for shielding the label material layer 8 of the optical disc 3 from the light 60 from the light source 56 and areas for passing the red light 60 through to the label material layer 8. The label mask 57 with a label information pattern is placed between the light source 56 and the label material layer 8. The exposed areas 58 of the disc 3 are bleached and the shielded areas 59 are kept in the initial state resulting in optical contrast. This embodiment based on illumination via a mask (57) is particularly suited for applying the same information to a multitude of discs.

FIG. 7 is a schematic cross section of a double sided optical disc 3 according to the present invention from which data is being read by a reading laser beam. The optical disc comprises most features already shown in FIG. 2. In FIG. 7 the label 7 of the optical disc 3 shown in FIG. 2 is omitted and a second data layer 15, a second substrate layer 19 and a second label material layer 18 are included. The device for reading data from the optical disc 3 is equipped with a first lens 2 and means for producing a first reading laser beam 1 for reading data from the first data layer 5 at one side of the disc 3 and a second lens 22 and means for producing a second reading laser beam 21 and a lens 22 for reading data from the second data layer 15 at the other side of the disc 3. In an alternative embodiment the device does not comprise means for producing a second reading laser beam 21 and the data from the data layer 15 can be read after ejecting the disc 3 turning the disc 3 upside down and placing the disc 3 back into the device. A label writing device for applying labels to both sides of the disc shown in FIG. 7 may also be equipped with one or two laser beam 11 producing means.

FIG. 8 is a schematic cross section of another double sided optical disc according to the present invention showing two options for placement of the label material. In the previous examples the label material layer 8 was situated at the surface of the optical disc 3 on the substrate layer 9. As can be seen in FIG. 8, the label material layer 8 may also be placed under the substrate layer 9, on the data layer 5 (upper side of the disc in FIG. 6) or between two substrate layers 19 (lower side of the disc in FIG. 6).

FIG. 9 is a schematic cross section of a double sided optical disc according to the present invention showing two additional options for placement of the label material. At the upper side of the disc 3 shown in FIG. 9 the transparent layer 4 comprises two label material layers 8 and 8′, separated by a substrate layer 9. In alternative embodiments the label material layers are placed directly upon each other or the transparent layer 4 comprises more than two label material layers. When the transparent layer 4 comprises at least two label material layers with different label materials, having different optical properties, a multi color label may be applied. In another embodiment of a multi colored label one label material layer comprises at least two different label materials. For two label materials with different absorption spectra laser beams 11 at different wavelengths are needed for affecting the reflection and absorption of both materials. At the lower side of the disc 3 shown in FIG. 9 the label material 13 is dispersed in a substrate layer. Such a label material layer 10 may be obtained by mixing the label material with the substrate material before forming a transparent layer on the disc 3.

It is noted that a label material layer which has a reflection or absorption being affectable by illuminating may also be attached to a non laser entry side of an optical disc. In this event the label material need not be transparent for light at the wavelength of a reading laser beam or a writing laser beam. Hence a record carrier with a writable label on the side opposite to the laser entry side is provided.

It is noted that in this document the word ‘comprising’ does not exclude the presence of other elements or steps than those listed and the word ‘a’ or ‘an’ preceding an element does not exclude the presence of a plurality of such elements, that any reference signs do not limit the scope of the claims, that the invention may be implemented by means of both hardware and software, and that several ‘means’ may be represented by the same item of hardware. Further, the scope of the invention is not limited to the embodiments, and the invention lies in each and every novel feature or combination of features described above.

1. An optical disc (3) for storing data, the optical disc comprising at least one data layer (5, 15) and a transparent layer (4, 14), the data being retrievable from the data layer (5, 15) via the transparent layer (4, 14) by a reading laser beam (1, 21), the transparent layer (4, 14) comprising label material for forming a label at a laser entry side of the disc by reflection or absorption of light at a range of wavelengths in the visual spectrum, the label material being substantially transparent for light at the wavelength of the reading laser beam (1, 21), characterized in that the reflection or absorption is affectable by locally illuminating the label material for the forming of the label.

2. An optical disc (3) as claimed in claim 1, wherein the transparent layer (4, 14) comprises at least one substrate layer (9, 19) and at least one label material layer (8, 18).

3. An optical disc (3) as claimed in claim 1, wherein the transparent layer (4, 14) comprises label material (13) dispersed in a substrate layer for constituting a label material layer (10).

4. An optical disc (3) as claimed in claim 1, wherein the label material is an organic photosensitive material.

5. An optical disc (3) as claimed in claim 1, comprising label material of which the reflection or absorption is affectable by locally illuminating the label at a wavelength substantially different from a wavelength of the reading laser beam (1, 21) or a writing laser beam for writing data onto the data layer (5, 15) of the disc (3).

6. An optical disc as claimed in claim 1, wherein the transparent layer (4, 14) comprises at least a first label material and a second label material, in the first label material reflection or absorption of light at a first range of wavelengths being affectable by illuminating the material, in the second label material reflection or absorption of light at a second range of wavelengths being affectable by illuminating the material, the second range of wavelengths being different from the first range of wavelengths.

7. A method for applying a label to a laser entry side of an optical disc (3) as claimed in claim 1, the method comprising the step of illuminating the label material according to a label pattern for affecting reflection or absorption of light by the label material.

8. A method as claimed in claim 7 wherein a laser (11, 12) is used for illuminating the label material while scanning the disc (3) according to the label pattern.

9. A method as claimed in claim 7 wherein a light source (56) is used in combination with a label mask (57) for illuminating the label material according to the label pattern.

10. A device (52) for applying a label to a laser entry side of an optical disc (3) as claimed in claim 1, the device (52) comprising means (54, 56) for illuminating the label material according to a label pattern at a wavelength suitable for affecting the reflection or absorption of light by the label material.

11. A device (52) as claimed in claim 10, wherein the means (54) for locally illuminating comprise means (55) for producing a laser beam (11) for illuminating the label material at the wavelength suitable for affecting the reflection or absorption of light by the label material, positioning means for positioning the laser beam (11) at areas of the label material layer (8, 10, 18) in which areas the reflection or absorption is to be affected and focusing means for focusing the laser beam to obtain a laser spot with desired dimensions on the label material layer (8, 10, 18).

12. A device (52) as claimed in claim 10, further comprising means for reading data from or writing data onto the disc (3).

13. A device (52) as claimed in claim 10, arranged for applying a label to a disc as claimed in claim 6, wherein the means (54) for locally illuminating comprise means for producing a second laser beam for illuminating the second label material.
